(19) United States
(12) Patent Application Publication
(10) Pub. No.: US 2005/0217479 A1
(43) Pub. Date: Oct. 6, 2005

(54) Helium recovery from gas streams

(75) Inventors: Patrick W. Hale, Houston, TX (US); Kaaeid A. Lokhandwala, Fremont, CA (US)

Correspondence Address: MEMBRANE TECHNOLOGY AND RESEARCH INC., 1360 WILLOW ROAD SUITE 103, MENLO PARK, CA, 94025-1516, US

(73) Assignee: Membrane Technology and Research, Inc., Menlo Park, CA (US)

(21) Appl. No.: 10/817,085

(22) Filed: Apr. 2, 2004

(51) Int. Cl. B01D 53/22

(52) U.S. Cl. 95/53

(57) ABSTRACT

Processes for recovering helium from reject gas streams of various types that arise during natural gas processing. The processes include a membrane gas separation step. The reject gas stream is treated in the membrane separation step to yield a helium-enriched permeate stream and a helium-depleted residue stream. The permeate stream is sent for further helium separation or purification in the gas plant or at another facility or sold as crude helium. The residue stream is discharged from the process to a vent line, fuel line, purge line or the like.

### FIELD OF THE INVENTION

The invention relates to helium recovery. More particularly, the invention relates to the use of gas separation membranes and processes to capture helium from vent gas streams, fuel gas streams and the like.

### BACKGROUND OF THE INVENTION

Helium is an inert, buoyant gas with many specialized uses. Helium is found in natural gas, typically in concentrations up to a few percent, and occasionally as high as 7% or even 10%. The gas is recovered and purified by a series of steps often involving pretreatment, cryogenic distillation and pressure swing adsorption (PSA).

The pretreatment train generally includes multiple operations to remove dust, water, acid gases (carbon dioxide and hydrogen sulfide), and C₃₊ hydrocarbons. The remaining gas is cooled to cryogenic temperatures and distilled, creating a liquid natural gas bottoms product and a crude helium overhead product. The liquid natural gas is typically expanded to provide cooling to the incoming feed gas and then sent to the gas pipeline. The crude overhead can be further processed by cryogenic distillation at lower temperatures. Alternatively or in addition, the overhead gas can be treated by separation in one or more PSA steps, yielding a purified helium product and various tail gas or reject gas streams produced when the beds are run through the regeneration sequence.

These operations are well understood in the gas processing industry and are described in numerous patents going back to the 1960s ( see, for example U.S. Pat. Nos. 3,126,266; 5,089,048 and 5,329,775) as well as in well known reference books, such as the Kirk-Othmer Encyclopedia of Chemical Technology.

Helium recovery operations provide a range of helium products, varying from crude helium, most typically containing down to about 50% helium mixed with nitrogen and other inert gases, to grade A helium, of 99.995% or better purity. Commonly, the gas is processed in a natural gas processing plant only as far as crude helium. The crude helium is then transported to a storage facility, where it is held as a reserve until it is released to a specialized helium purification plant that produces high purity helium for the market.

At each stage of gas processing and purification, helium losses can occur. It is common practice in gas fields to use gas engines or turbines to run field equipment. A side stream of the raw gas is taken to be used as engine fuel. If this gas is destined for a helium recovery plant, a portion of the helium in the stream may be lost in the engine fuel before the gas even reaches the plant.

When the gas reaches the plant, vent streams, fuel gas streams and various other purge streams and tail gas streams may be created by the individual unit operations.

As a first example, the gas processing plant may include a cold box section incorporating one or more cryogenic distillation columns. If there is no use for the nitrogen produced by these operations, it may simply be vented to the atmosphere, thereby also venting any helium that remains mixed with the nitrogen. If the plant has methane/nitrogen separating columns, but no facility for separating helium from nitrogen, essentially all of the helium that was present in the raw gas will be lost in this way with the vented nitrogen.

As a second example, fuel gas is needed in the gas processing plant for a variety of uses. These include, but are not limited to, operation of reboilers for the regeneration of amine and glycol solutions. It is well known and common practice to take a side stream from the main gas product line to use as combustion fuel for this purpose. If the fuel gas contains helium, the helium will pass through the combustion step as an inert gas and will be lost in the vented combustion exhaust.

Modem helium recovery and purification plants operate at high recovery efficiencies, as high as 98% or better. Nevertheless, this means that up to 2% or more of the helium present in the raw natural gas stream is lost in one or more non-product streams of the type described above. These streams are often routed to the plant fuel header at best, or simply flared or vented.

World demand for helium is increasing, and this is expected to put pressure on production facilities as demand for high-purity helium products begins to outstrip supply. Helium prices, already high (about $50/thousand cubic feet) increased by about 10% from 2003 to 2004. In light of these trends, processing methods that reduce the above-described types of helium losses are needed.

A few patents suggest processes using gas separation membranes to separate helium from other gases. U.S. Pat. No. 3,324,626, to Sinclair Research, describes a process to unload a cryogenic fractionation column by using one or more membrane stages to concentrate the helium in the raw natural gas feed stream before it is sent to the column.

U.S. Pat. No. 4,717,407, to Air Products and Chemicals, discloses combinations of non-membrane and membrane separation for helium recovery from gas streams. The non-membrane process may be cryogenic distillation or any other process. The membrane step is used to treat helium-rich streams and the non-membrane step to treat helium-lean streams. In this way, the membrane step produces the finished helium product stream.

U.S. Pat. No. 5,224,350, to Advanced Extraction Technologies, concerns a helium purification train including a lean oil extraction step. The extraction step removes C₃₊ hydrocarbons from the gas stream; the overhead from the extraction column is treated by membrane separation to recover a helium-rich permeate and a nitrogen-rich residue. The membrane permeate is treated in a PSA unit to yield high purity helium.

U.S. Pat. No. 5,632,803, to Nitrotec, is similar in concept to U.S. Pat. No. 3,324,626, in that it describes a process in which membranes are used to unload a helium purification facility. In this case, a membrane separation step is performed upstream of pressure swing adsorption (PSA) to increase the helium concentration of the feed to the PSA steps.

In each of these processes, the membrane step is a unit line operation within the main helium recovery and purification train. None of the above references provides a way to recover helium from fuel gas streams, vent gas streams or other gas processing plant reject streams.

### SUMMARY OF THE INVENTION

The invention is a process for capturing helium from vent gas streams, fuel gas streams, and other such waste, reject or non-product streams that arise in gas processing operations. Streams that may be treated by the process arise from various sources along the train of gas processing operations, and have usually been through at least one gas separation step to separate methane from other gases or vapors.

The streams have been rejected or withdrawn from the gas processing train and are to be disposed of, for example by venting, flaring or reinjection, or to an ancillary, non-product gas use, such as fuel gas or purge gas. That is, they may be characterized in a general way as effluent, side or secondary streams, not end-of-pipe product streams. Before the availability of our process, the streams would have been disposed of to their destination without any additional helium recovery.

For simplicity and convenience, these streams are referred to herein by the collective term reject gas stream.

The process involves treating such gas by membrane separation before it is sent to its ultimate destination. The membranes used in the treatment are selectively permeable in favor of helium over other gases in the stream, particularly nitrogen and methane.

In a basic aspect, the invention comprises the following steps:
(a) providing a membrane unit having a feed side and a permeate side and containing a membrane selective for helium over nitrogen and helium over methane;
(b) passing a reject gas stream in a gas processing plant as a feed stream across the feed side under conditions in which transmembrane permeation occurs;
(c) withdrawing from the feed side as a residue stream a treated reject gas stream depleted in helium compared with the feed stream;
(d) withdrawing from the permeate side as a permeate stream a gas mixture enriched in helium compared with the feed stream;
(e) disposing of the treated reject gas stream by a method selected from the group consisting of (i) venting, (ii) flaring, (iii) reinjecting, (iv) using as fuel gas and (v) using as purge gas;
(f) disposing of the gas mixture by a method selected from the group consisting of (i) storage, (ii) transport to a helium separation facility, (iii) sale and (iv) return for additional processing within the gas processing plant.

The residue stream is substantially depleted in helium, and is discharged from the gas processing train as a purge stream, vent stream or fuel gas stream, for example. By removing helium from this stream before it is disposed of, the process provides a selective purging or venting capability, in which the proportionate loss of helium per unit volume of gas purged or vented is much lower than with prior art processes.

The enriched helium-containing gas mixture that is captured in the permeate stream may optionally be returned within the gas processing plant at any convenient point, either upstream or downstream of the point from which it was withdrawn. In the alternative, the gas may be sold as a crude helium product, stored for subsequent treatment on- or off-site, or may be transported to a distant helium separation facility, such as a plant with crude helium production capability or a helium purification plant. Any method of disposition of this stream that ultimately results in a recovered helium product of some sort is within the scope of the invention.

The reject stream to be treated by the process of the invention may contain helium at low or high concentrations, such as from less than 1% to as much as 75%, 80% or more. Most frequently, the stream contains no more than about 10% helium. The other components of the stream typically include methane, nitrogen and/or other inert gases, carbon dioxide, ethane, propane and other hydrocarbons or water vapor, depending on the position along the gas processing train where the reject stream arises.

Before being passed to the membrane separation step, the reject gas stream may be adjusted in pressure, temperature or both if desired.

A driving force for transmembrane permeation is usually provided by a pressure difference between the feed and permeate sides of the membrane. If the reject stream is already at high enough pressure to provide adequate transmembrane driving force, it may be passed to the feed inlet of the membrane unit without further compression. Alternatively the driving force may be provided or increased by compressing the feed gas, drawing a vacuum on the permeate side or both, as convenient.

Any type of membrane that can provide adequate helium flux and selectivity for helium over the other principal components of the reject gas may be used. Preferably the membrane is a polymeric membrane, and most preferably the membrane is made from a fluorinated, glassy polymer.

The process of the invention can achieve substantial reductions in helium loss with a single membrane separation stage. More stages or steps may optionally be used as desired to increase the concentration of helium in the permeate or otherwise adjust the composition of the residue or permeate streams.

In a second aspect, the invention is a process for treating helium-containing vent gas from a gas processing plant. In this aspect, the invention includes the following steps:
(a) providing a membrane unit having a feed side and a permeate side and containing a membrane selective for helium over nitrogen;
(b) passing at least a portion of the vent gas as a feed stream across the feed side under conditions in which transmembrane permeation occurs;
(c) withdrawing from the feed side as a residue stream a treated vent gas stream depleted in helium compared with the feed stream;
(d) withdrawing from the permeate side as a permeate stream a gas mixture enriched in helium compared with the feed stream;
(e) venting the residue stream.

Such a process is particularly useful in gas plants that do not have any helium recovery equipment in the gas processing line. For example, if the plant includes a nitrogen rejection unit (NRU) but no helium/nitrogen separation column, most of the helium present in the raw gas will go with the overhead nitrogen stream from the nitrogen/methane separation steps. If there is no commercial use for the nitrogen generated in this way, the nitrogen is not recovered as a product, and may simply be vented to the atmosphere. Our process can be used to treat the vent stream before it is discharged to the atmosphere to capture a helium-enriched permeate stream that may subsequently be processed to make crude or purified helium.

In a third aspect, the invention is process for treating helium-containing fuel gas from a gas processing plant. In this aspect, the invention includes the following steps:
(a) providing a membrane unit having a feed side and a permeate side and containing a membrane selective for helium over methane;
(b) passing at least a portion of the fuel gas as a feed stream across the feed side under conditions in which transmembrane permeation occurs;
(c) withdrawing from the feed side as a residue stream a treated fuel gas stream depleted in helium compared with the feed stream;
(d) withdrawing from the permeate side as a permeate stream a gas mixture enriched in helium compared with the feed stream;
(e) burning the residue stream as fuel.

Such a process is particularly useful in gas plants that do not include an NRU, or if the plant includes an NRU but it is desired to take off the fuel gas upstream of the NRU. The residue stream forms the fuel gas stream and is burnt to provide heat for reboilers, engines or other equipment. The helium-enriched permeate stream may be returned to the process train or sent off-site for further treatment or otherwise disposed of as described above.

In a fourth aspect, the invention is process for treating helium-containing gas that has been taken off from the main process train to use as a purge gas stream for any of the common uses of purge gas in a gas plant, such as providing a dry, insulated controlled environment for instruments or cold boxes, or for blanketing storage tanks. In this aspect, the invention includes the following steps:
(a) providing a membrane unit having a feed side and a permeate side and containing a membrane selective for helium over nitrogen;
(b) passing at least a portion of the purge gas stream as a feed stream across the feed side under conditions in which transmembrane permeation occurs;
(c) withdrawing from the feed side as a residue stream a treated purge gas stream depleted in helium compared with the feed stream;
(d) withdrawing from the permeate side as a permeate stream a gas mixture enriched in helium compared with the feed stream;
(e) using the treated purge gas stream as a purge stream within the gas processing plant.

In yet other aspects, the invention is a process of the same type as those identified above for treating other reject streams of all kinds, including, but not limited to, streams that are to be sent to flare and streams that are to be reinjected into the formation from which the raw gas originates for any reason.

Other objects and advantages of the invention will be apparent from the description of the invention to those of ordinary skill in the art.

It is to be understood that the above summary and the following detailed description are intended to explain and illustrate the invention without restricting its scope.

### BRIEF DESCRIPTION OF THE DRAWINGS

FIG. 1 is a schematic flow diagram showing the process of the invention in a general basic embodiment.

FIG. 2 is a schematic flow diagram showing a representative gas processing train to produce crude helium and ultimately purified helium, and in which the membrane separation step is used to treat a purge gas stream.

FIG. 3 is an expanded schematic flow diagram of a membrane separation step of the type shown in FIG. 2.

FIG. 4 is a schematic flow diagram showing the use of the process of the invention to treat a nitrogen vent stream from the cold box of a nitrogen rejection unit (NRU).

FIG. 5 is a schematic flow diagram showing the use of the process of the invention to treat a fuel gas stream withdrawn upstream of the cold box in a gas processing plant.

FIG. 6 is a schematic flow diagram showing the use of the process of the invention to treat a fuel gas stream withdrawn upstream of the amine gas-sweetening unit and the dehydration unit in a gas processing plant that has no helium separation capability.

FIG. 7 is a schematic flow diagram showing the use of the process of the invention to treat a fuel gas stream withdrawn upstream of several unit operations in a gas processing plant with nitrogen or helium separation capability.

### DETAILED DESCRIPTION OF THE INVENTION

All percentages herein are by volume unless otherwise stated.

In a first aspect, the invention is a membrane-based gas separation process for capturing helium from a reject gas stream at a gas processing plant.

By a reject gas stream, we mean any gas stream that has been withdrawn or rejected from an operation in a gas processing plant, and the disposition of which is to be either (i) discharge from the plant, such as to vent, flare or reinjection, or (ii) use for an ancillary function, such as fuel gas or purge gas.

In other words, the feed stream to our process can be described as an effluent stream, secondary stream, side stream or ancillary stream.

Such streams arise from various sources along a train of gas processing operations, and have usually been through at least one gas separation step to separate methane from other gases or vapors.

Streams within this general definition include, but are not limited to, reject streams sent to vent, flare or reinjection, side streams used as fuel gas to run plant equipment, such as engines, turbines, boilers, reboilers or fuel cells, and miscellaneous streams taken off to provide purge gas for regeneration of unit operations, insulation of cold boxes or the like, blanketing of storage tanks and so on.

The gas streams to be treated by the process of the invention contain helium. The helium concentration in the reject gas stream may be any value, such as from 1% or less to 50% or more. In many but not all cases, helium is a minor component (less than 50%) of the stream, and typically the helium concentration is below 10%.

In addition to helium, the reject gas streams to be treated by the process of the invention may contain any other gases, depending on their source. Typically, the reject stream also contains nitrogen, methane or both. Commonly, very small amounts of other inert gases, such as argon or neon, or other permanent gases, such as hydrogen, may also be present.

Treatment to remove acid gases, water, C₂₊ or C₃₊ hydrocarbons and any other relatively high-boiling components is usually carried out at the front of the train of gas processing operations before separation of methane and nitrogen. Often, therefore, the gas streams on which our process operates contain these types of components only in trace quantities, if at all. In this case, the stream is substantially free of materials known to damage gas separation membranes or adversely affect their performance, and can be passed as a feed stream to the membrane without further adjusting the composition in any way. If any additional composition adjustment is desired, however, it may be carried out within the scope of the invention.

If the gas stream to be treated originates further upstream in the gas processing plant it may contain one, some or all of C₃₊ hydrocarbons, hydrogen sulfide, carbon dioxide and water vapor in significant amounts. In this case, these may either be removed or reduced before the reject stream is passed to the membrane separation step, or membranes that can operate in their presence should be used, as discussed below.

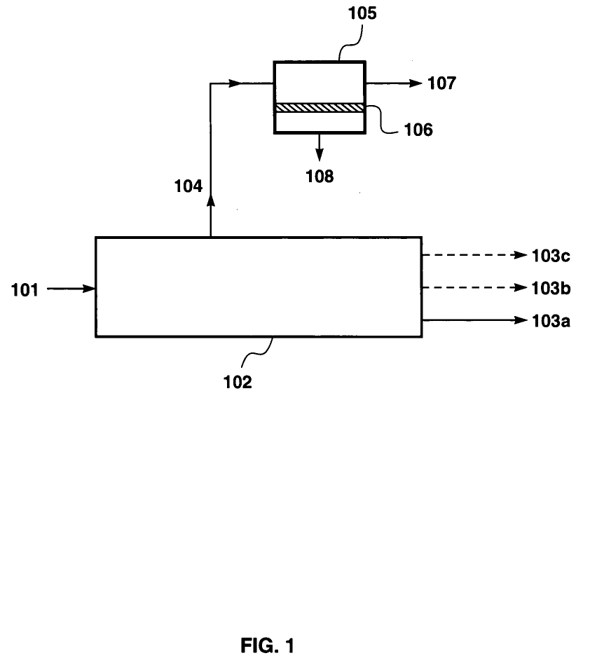

The process of the invention is shown in the most simple schematic form in FIG. 1. Referring to this figure, a raw gas stream, 101, is introduced into a series or train of one or more gas processing steps, 102, in a gas processing plant, where it is processed to make at least one gas product 103.

The raw gas stream is any gas stream that contains helium. Usually, but not necessarily, this gas is natural gas. Stream 101 may be, for example, raw gas as it comes from a gas well, or may have already been pretreated or partially pretreated as mentioned above to remove entrained solid or liquid particles, water vapor, hydrocarbons or other contaminants, by any of the techniques known in the natural gas processing industry.

Gas stream 101 is treated in gas processing steps 102 to yield one or more product streams 103. As non-limiting example, the figure indicates three product streams. Typically one product, 103a is a methane product that forms pipeline grade natural gas. Other products may include, but are not limited to, nitrogen, crude helium, natural gas liquids (NGL) or carbon dioxide. Streams 103b and 103c may be any of these. For example, if the gas processing plant includes a nitrogen rejection unit (NRU), stream 103b may be nitrogen and stream 103c may be NGL. If the plant includes both an NRU and a crude helium production column, stream 103b may be nitrogen and stream 103c may be crude helium.

Process train 102 includes one or a series of unit gas separation operations. Such operations are well known in the art and include, but are not limited to, condensation, distillation, flash evaporation, absorption, adsorption, molecular sieving, and membrane separation.

For example, a typical representative process train may include a slug catcher to remove free liquid, inlet compressors and air coolers to adjust the pressure and temperature, an amine system to remove carbon dioxide and hydrogen sulfide, a molecular sieve to remove water, heat exchangers and a turboexpander to cool the gas, vessels to separate condensed hydrocarbons from the gas, a cryogenic fractionator to separate ethane and heavier hydrocarbons, and another cryogenic fractionator to separate methane from nitrogen and helium.

Such a train would result in a condensate composed of mainly C₅₊ hydrocarbons, water and acid gas that may be vented or processed to recover sulfur, a hydrocarbon liquid stream that may be sold as NGL product, a hydrocarbon gas stream that may be sold as natural gas product, and a nitrogen-helium mixture that may be sold as is, or after yet another fractionation, as crude helium.

A helium-containing reject gas stream, 104, of the type discussed above is withdrawn from the gas processing train of steps, 102, and introduced as feed stream into membrane separation step 105. The position from which stream 104 is withdrawn may be anywhere along train 102, from upstream of the first operation to downstream of the last. For instance, if the first operation in the train is a dehydration step, a side stream intended for use as a fuel stream in another operation might be taken from the feed to the dehydration unit. Likewise, if the last operation is cryogenic fractionation into a methane-rich bottoms product and a nitrogen overhead vent stream, stream 104 might be the totality of the nitrogen vent stream.

Membrane separation step, 105, uses a membrane separation unit equipped with gas separation membranes, 106, that are selective in favor of helium over nitrogen and methane, and that provide acceptable transmembrane flux.

Preferably the membranes are polymeric membranes. The helium atom is extremely small (about 1 Å diameter) compared with other gas molecules (nitrogen has a molecular kinetic diameter of 3.64 Å and methane of 3.8 Å). As a result, both most glassy and most rubbery polymer membranes, with a few exceptions, offer selectivity in favor of helium over methane, nitrogen and other gases. Typical data, showing representative selectivities and permeabilities for many rubbery and glassy materials may be found in L. M. Robeson, “Correlation of separation factor versus permeability for polymeric membranes”, Journal of membrane Science, 62, pages 175-178, 1991.

In general, it is preferred that the membranes offer a selectivity for helium over nitrogen and for helium over methane of at least 5, and most preferably at least 10, 15, 20, 30 or more, when in use in the process. Rubbery polymers tend to have lower selectivity than glassy polymers and are less preferred. Representative glassy membrane materials that may be used to make membranes suitable for our process include, but are not limited to, polysulfone, cellulose acetate, polyamide, polyaramid, polyimide, polyetherimide, polyester and polycarbonate.

Particularly preferred membranes are made from fluorinated dioxoles, fluorinated dioxolanes or fluorinated cyclically polymerizable alkyl ethers and are of the type disclosed in U.S. Pat. Nos. 6,361,582 and 6,361,583, which patents are incorporated herein by reference. Polymers for preparing these membranes are available from Asahi Glass Company, of Tokyo, Japan under the trade name Cytop®, and from Solvay Solexis, Thorofare, N.J., under the trade name Hyflon®AD.

The fluorinated membranes of the previous paragraph are especially preferred if the reject stream contains significant amounts of carbon dioxide, C₃₊ hydrocarbons or water vapor because they offer better chemical and mechanical stability in the presence of these materials than presently available cellulose acetate, polysulfone or polyimide membranes, for example.

The membranes may have any structure known in the gas separation membrane art, such as integral asymmetric or composite, and may be housed in any convenient type of housing and separation unit. We prefer to prepare the membranes as composite membranes in flat-sheet form and to house them in spiral-wound modules. However, flat-sheet membranes may also be mounted in plate-and-frame modules or in any other way. If the membranes are prepared in the form of hollow fibers or tubes, they may be potted in cylindrical housings or otherwise.

To achieve high transmembrane fluxes, the selective layer of the membrane responsible for the separation properties should preferably be sufficiently thin that the membranes provide a pressure-normalized nitrogen flux, as measured with pure nitrogen at 25° C., of at least about 1 gpu (1 gpu=1×10⁻⁶ cm³(STP)/cm²·s·cmHg), more preferably at least about 10 gpu, yet more preferably at least about 20 gpu, and most preferably at least about 50 gpu.

To achieve fluxes of these orders, the selective layer responsible for the membrane separation properties should, preferably, be no more than about 10 μm thick, and more preferably no more than about 5 μm thick, and most preferably no more than about 1 μm thick. If the fluorinated cyclic polymers typified by the Hyflon® and Cytop® product ranges are used for the selective layer of the membrane, slightly thicker membranes may be acceptable, because of the high intrinsic permeability of these polymers.

Various membrane product lines that are offered commercially for other types of gas separation, such as oxygen/nitrogen separation, hydrogen/nitrogen separation or carbon dioxide/methane separation include membranes suitable for use in the invention. Such membranes are available from Air Liquide under the trade name Medal™, from Innovative Gas Systems under the trade name Generon®, from Kvaerner Membrane Systems (formerly Grace Membrane Systems), from UOP under the trade name Separex™, and from Ube Industries of Japan.

Membrane feed stream 104 may be introduced into the membrane separation step 105 at any temperature consistent with membrane operating requirements. As a general rule, the permeability of a polymeric membrane increases with increasing operating temperature; on the other hand, the selectivity increases as the operating temperature decreases. Since most membranes have adequately high selectivity at ambient temperatures or above for helium over nitrogen and helium over methane, it is generally not necessary to cool the feed stream to increase selectivity.

If the feed stream to the membrane is very cold, it is preferred to warm it, such as to ambient temperature to maintain good transmembrane flux.

A driving force for transmembrane permeation is usually provided by a pressure difference between the feed and permeate sides of the membrane. Depending on their source, the gas streams amenable to treatment according to the process of the invention vary widely in pressure, from close to atmospheric pressure to 1,000 psia, 1,400 psia, 1,500 psia or higher.

If stream 104 is already at high enough pressure to provide adequate transmembrane driving force, it may be passed to the feed inlet of the membrane unit without further compression. If the stream is at very high pressure, such as above about 1,000 psia, the pressure may be reduced if desired.

Alternatively the driving force may be provided or increased by compressing the feed gas. Preferably, the feed stream pressure should be at least 200 psia and more preferably at least 250 psia.

The pressure on the permeate side should be maintained at a value to give sufficient pressure difference for adequate flux, as well as sufficient pressure ratio for adequate separation.

The ratio feed pressure/permeate pressure is known as the pressure ratio. The mathematical relationship between pressure ratio and selectivity predicts that if the numerical value of the pressure ratio is much smaller than the selectivity, then the process is pressure-ratio limited. In this case, the permeate concentration is essentially independent of the membrane selectivity and is determined by the pressure ratio.

In the present process, the selectivity of the membranes for helium over methane or nitrogen is likely to be as relatively high, such as 10, 20, 30, 50 or more, so the process may operate in the pressure-ratio-controlled range. In this case, a higher pressure ratio will give a better separation of the components of the feed stream, and a pressure ratio of at least 10, and more preferably at least 15, 20 or higher is preferred if possible.

In principle, the pressure difference and pressure ratio can both be increased by lowering the pressure on the permeate side by drawing a partial vacuum. However, it is preferred to maintain the permeate side at atmospheric pressure or above, to facilitate return of the permeate stream within the processing train or removal to storage or an off-site destination. As general guideline, the preferred permeate-side pressure is typically between about 15 psia and 150 psia.

The feed stream flows across the feed side of membranes 106. Helium permeates the membranes preferentially, so that the membrane separation step results in a residue stream, 107, that is depleted in helium compared with the membrane feed stream, 104.

Since the membranes permeate helium selectively, any degree of helium removal from the residue stream may be obtained, by increasing the portion of the total feed stream gas that permeates the membrane. The ratio of total permeate flow to total feed flow is known as the stage-cut and is usually expressed as a percentage. For example, starting with a membrane feed stream containing 50% helium and 50% nitrogen, a residue stream that contains 60%, 70%, 80%, 90%, 95% or 99% nitrogen could be produced by increasing the stage-cut. Thus helium losses in the residue stream can be cut to a very low level by operating the membrane separation step at high stage-cut.

The membrane area required to perform the separation scales with the stage-cut, as does the compressor energy required to recompress the permeate, if necessary. In a specific situation, capital and operating cost considerations may impose an upper limit on stage-cut. Nevertheless, it is envisaged that the process of the invention will often be beneficial when operated at relatively high stage-cut, such as at least 30%, 40%, 50%, 60%, or more.

In general, subject to other considerations, it is preferred to operate the process such that the amount of helium captured or recovered in the enriched permeate gas mixture is at least 40%, more preferably at least 50% of the amount of helium contained in the feed gas sent to our process. The ability to tailor the composition of the residue stream, and therefore, to gain a high degree of control over the amount of helium that is lost or recaptured is an attractive feature of the invention.

The residue stream is discharged from the membrane separation step as the treated reject stream and is passed to its original destination as a vent, flare, reinjection, fuel or purge stream or the like.

The membrane separation step also results in permeate stream, 108, which is enriched in helium compared with feed stream 104. A goal of our process is to capture helium in such a way that it may be added to other helium containing process or product streams. Thus, the enriched gas mixture 108 may be disposed of to any destination that achieves this end.

If the gas processing plant includes a cryogenic fractionation column or other operation producing crude helium, the permeate gas may be returned within the gas processing train at any convenient point. This will often require recompressing the permeate gas.

If the gas processing plant does not include any helium production capability, the permeate gas is sent off-site to a helium recovery or purification facility. This may be done in any way, including by pipeline, if one is available, or by compressing and storing the gas for later shipping by tanker truck-to the helium plant.

If the process is operated at high stage-cut as discussed above, significant amounts of the less permeable gases present in the feed stream will permeate the membrane. In this case, the composition of the permeate stream may be only slightly richer in helium than the feed stream, and it is preferred to return the permeate stream to the gas production line at a point close to that from which it was removed.

If the permeate gas mixture has a relatively high helium concentration, such as 10% helium, 15% helium, 20% helium or higher it may be saleable as crude helium without additional treatment.

Especially if the permeate gas mixture is to be sold or sent off-site for purification, we prefer to use a membrane configuration that results in an enriched permeate gas mixture containing at least about 10% helium. Such arrangements are discussed in more detail below.

Membrane separation step, 105, may be carried out using a one stage membrane unit, that is a unit containing a single membrane module or bank of membrane modules. This configuration is simple and is preferred if enrichment of the helium content of the permeate stream is relatively unimportant, for example if the permeate stream is to be returned to the process line within the gas plant.

It is also possible to use a more complicated membrane array, in which either the residue or the permeate stream, or both, from the first bank of modules is passed to a second or subsequent bank of modules for further processing. Such a scheme is useful when specific composition targets for both the residue and permeate streams that are significantly different from the feed stream must be met. Such multi-stage or multi-step processes, and variants thereof, will be familiar to those of skill in the art.

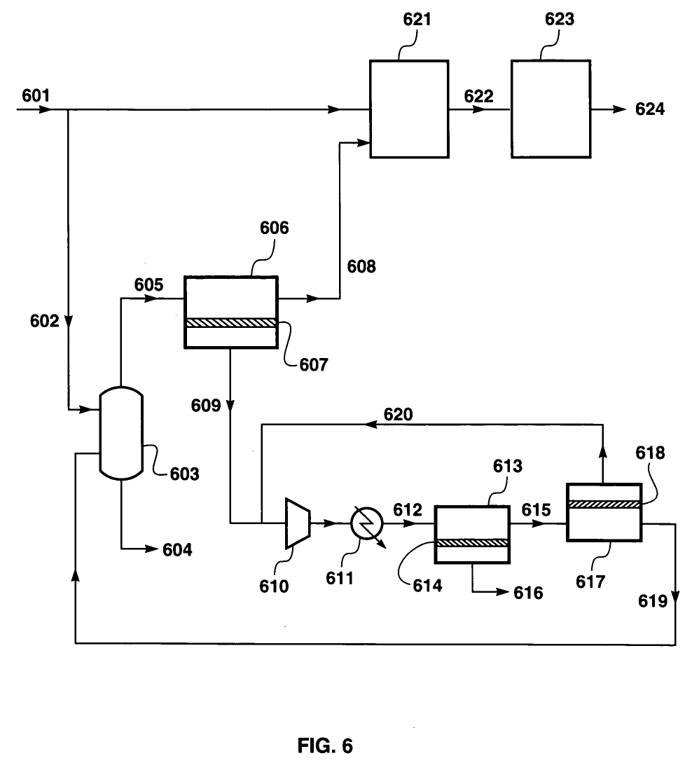

As non-limiting illustrations, a two-step process, in which the residue stream from the first step is sent to a second treatment step, can be used to treat a stream containing 50/50 helium nitrogen to produce both a relatively pure nitrogen stream and a relatively pure helium stream. The first step is operated at a relatively low stage-cut, such as 10% or less, to produce a permeate containing 90% or 95% helium. Because the stage-cut is low, the residue from this step still contains significant amounts of helium and can be passed without additional compression to a second step, operated at higher stage-cut, to reduce the residue from this step to a nitrogen stream containing only 5% or less helium. The permeate from the second step can be recirculated to the inlet of the first step. This type of design is shown as part of FIG. 6, described below.

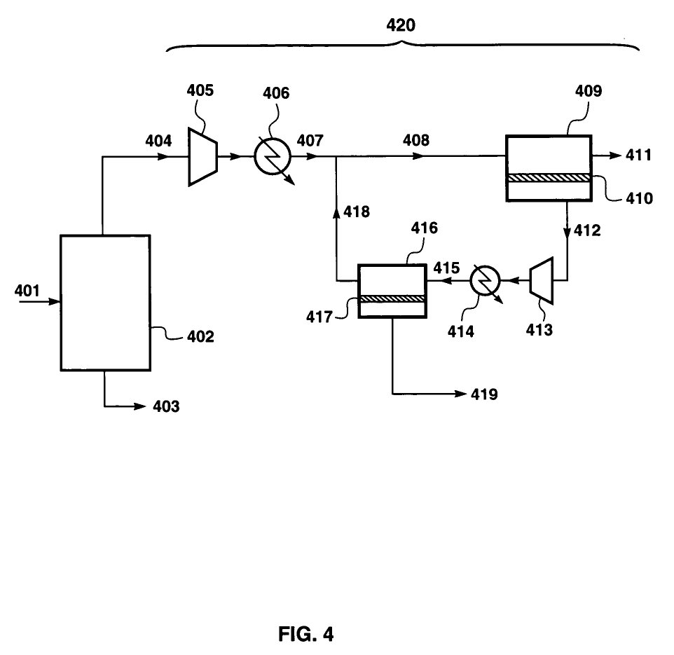

If significant enrichment of the permeate stream is required, such as to raise the helium concentration from only 1-2% in the reject stream to 20% or more in the permeate stream, for example to truck the gas off-site as crude helium, a two-stage design, such as that shown in FIG. 4, is preferred.

If a multi-step or multi-stage arrangement is used, the membranes used in the individual steps or stages may be the same or different. For example, if the gas contains carbon dioxide, a membrane stage using membranes that preferentially permeate carbon dioxide and reject helium, such as the polyamide-polyether block copolymer membranes described in U.S. Pat. No. 4,963,165 may be useful.

The invention is now described as it can be used in three types of application: to capture helium from nitrogen that is to be used as a purge gas; to capture helium from a cryogenic fractionation column vent; and to remove helium from fuel gas.

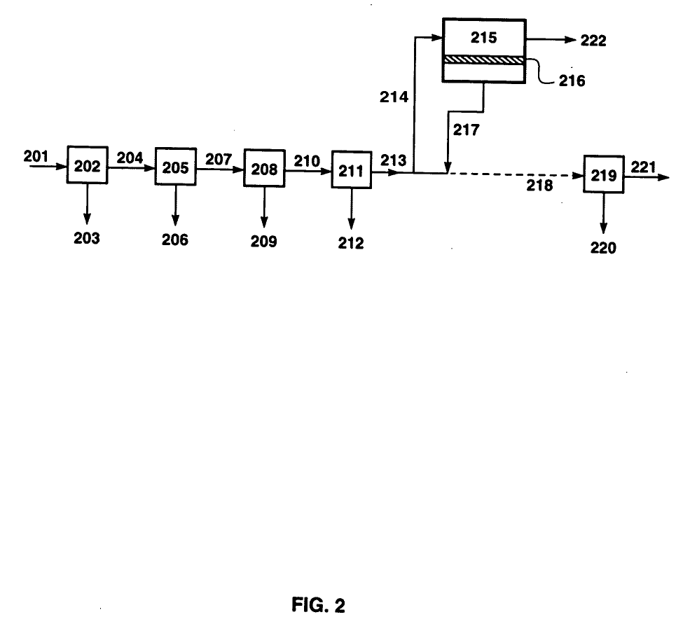

The invention in these aspects is shown in FIGS. 2-7. It will be appreciated by those of skill in the art that these are very simple schematic diagrams, intended to make clear aspects of the invention, and that an actual process train will usually include many additional components of a standard type, such as heaters, chillers, condensers, liquid pumps, gas compressors, blowers, other types of separation and/or fractionation equipment, valves, switches, controllers, pressure-, temperature, level- and flow-measuring devices and the like.

It will also be appreciated that the individual process steps should not necessarily be construed as being in close physical proximity, so that gas may be sent by pipeline over some distance from one unit operation to the next.

FIG. 2 represents application of our process to a side stream to be used as a purge gas. The side stream is taken from a cold box overhead stream. Referring to this figure, incoming gas stream 201 is a natural gas stream containing methane, nitrogen, helium, carbon dioxide, C₃₊ hydrocarbons and water vapor. The gas must be treated to achieve substantially total removal of all relatively high-boiling components before the cryogenic fractionation steps.

As the first step in the gas processing train, the gas passes through an acid gas removal step, 202, where carbon dioxide is removed by scrubbing the gas with an amine solution. After regeneration of the amine solution, acid gas stream, 203, is sent for disposal.

Sweetened gas stream, 204, is sent to dehydration step, 205. This step uses molecular sieving to remove water vapor. Water exits the molecular sieve system as stream 206. Sweet, dry gas stream, 207, now goes to a hydrocarbon removal step, 208, where the gas is cooled and separated into hydrocarbon stream 209 and stream, 210, comprising essentially just methane, nitrogen and helium, which is suitable for a cryogenic column feed.

This gas proceeds to methane removal step, 211, for cryogenic separation, and the remaining methane, 212, is liquified and removed. The overheard methane free gas, 213, is combined with permeate stream 217 (described below), to form product stream 218, which is suitable for sale as crude helium.

Ultimately, the crude helium stream is sent by pipeline or truck to helium purification plant, 219, where it is separated into high-purity nitrogen product stream, 220, and high-purity helium product stream, 221.

A purge stream, 222, is needed to for on-site use. Representative uses of this purge gas include, but are not limited to, maintaining a controlled atmosphere in the insulated cold box where step 211 takes place, maintaining a controlled atmosphere in instrument enclosures, and blanketing storage tanks containing hydrocarbons.

A portion of overhead stream 213 can be used for this purpose. A side stream, 214, is withdrawn from overhead stream 213 and passed as feed to membrane separation step, 215. In this step, the feed flows over the feed side of membranes 216, which are selectively permeable to helium over nitrogen. The residue stream, 222, from the membrane unit is enriched in nitrogen and depleted in helium. As explained above, the membrane separation step can be operated to achieve a high level of helium recapture, so that the residue stream may contain less than 10%, 5%, 2% or 1% helium, for example. In this way, very little helium is lost in the purge gas stream.

The residue stream is sent on for use as purge gas as originally intended.

The membrane separation step also produces helium-enriched permeate stream, 217, which is returned to the overhead line 213 to form gas stream 218. Typically the composition of stream 217 is only slightly helium richer than that of stream 214, so the composition of stream 218 remains close to that of stream 213.

A compressor, not shown, is normally required to recompress stream 217 to the pressure of stream 213. Alternatively, if either of streams 213 or 214 has been subject to compression, stream 217 may be returned to the suction side of the compressor used for that duty.

FIG. 4 represents the application of our process to recover helium from a nitrogen vent gas stream. Some gas processing facilities have no commercial use for nitrogen removed from natural gas. This gas is vented to atmosphere. If the facility does not have helium recovery, the nitrogen vent may contain helium.

A process arrangement indicated generally as 420 in FIG. 4 may be used to capture this helium. Gas stream 401 is assumed to have been pretreated to remove acid gases, water vapor and C₂₊ hydrocarbons. Stream 401 is separated in cryogenic fractionation step 402 into methane bottoms product, 403, and nitrogen vent gas, 404. The vent gas is fed to compression step, 405, and cooling step, 406, which adjust the gas conditions to at least 250 psia and near ambient temperature. The compressor discharge, 407, is then combined with recycle gas, 418, which is described below.

The combined stream, 408, enters the first membrane separation step, 409, equipped with membranes, 410, that are selective in favor of helium over nitrogen. The helium is removed by permeation through the membranes, 410, and leaves this step at lower pressure as the recovered helium first permeate stream, 412. The residue gas is depleted of helium and leaves the step as reject nitrogen stream, 411. This stream is passed to the required purge operation.

Permeate stream,412, is recompressed in compression step,413, and cooled in cooling step, 414, which adjusts the pressure and temperature to be suitable for the feed, 415, to the second stage membrane separation unit, 416. The stream passes into this step and over membranes, 417, which are again selective in favor of helium over nitrogen. Here stream 415 is separated into a permeate export helium stream, 419, and recycle gas stream, 418.

Depending on the destination of the export helium, it can have a composition suitable for crude helium sales or some lower helium concentration that allows economic transportation and further processing.

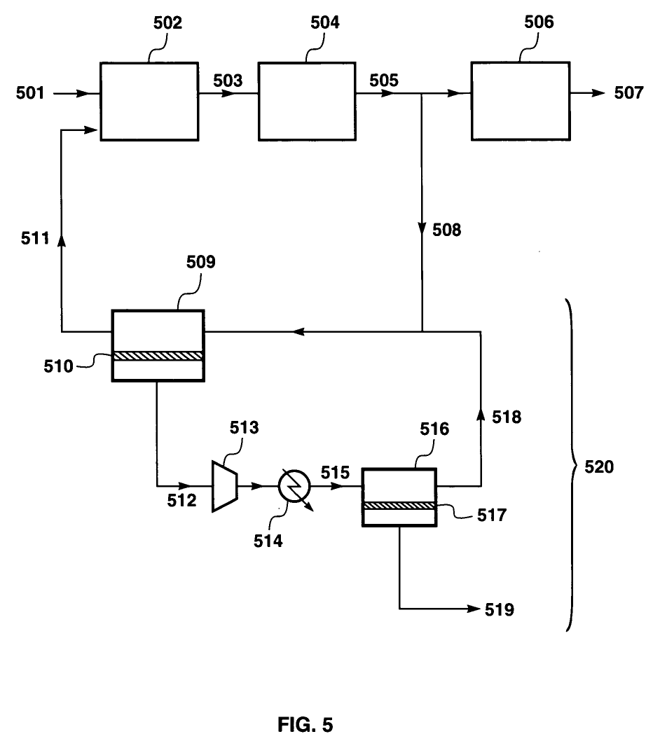

FIGS. 5, 6 and 7 represent the application of our process to recover helium from fuel gas streams taken from the process gas at different point in the process train.

Referring first to FIG. 5, this illustrates our process, indicted generally as 520, in the case where fuel gas is taken after removal of acid gas and water vapor, but before separation of methane from nitrogen. Gas stream, 501, may contain, for example, carbon dioxide, water vapor, methane, small amounts of other light hydrocarbons, nitrogen and helium. The gas is treated first in acid gas removal step, 502, and the sweetened gas 503, is sent to dehydration step, 504. Dry, sweet gas stream, 505, is sent to nitrogen rejection step, 506, where pipeline grade natural gas stream, 507 is produced.

Fuel is needed to heat the reboilers used to regenerate the amine scrubbing solution used in step 502. To provide this fuel, a small side stream, 508, is taken from stream 505. This fuel gas stream is combined with recycle gas, 518, described below and passed as the feed stream to membrane separation step, 509, which uses membranes, 510, that are selective for helium over methane and nitrogen.

Helium-enriched permeate stream, 512, leaves this step at lower pressure and is passed to another compression step, 513, and cooling step, 514. Recompressed, cooled gas, 515, is passed as feed into second membrane separation stage, 516, containing helium-selective membranes, 517. Here the gas is separated into a permeated export helium stream, 519, and recycle gas stream, 518. The export helium can then be transport to another location for further processing.

Residue stream, 511 , is withdrawn from the first membrane separation step, 509, and forms the treated fuel gas stream which is directed to the combustion fuel intake for the reboiler section of amine scrubbing step, 502.

FIG. 6 illustrates a process where fuel gas is taken at the front of the process train. Gas stream, 601, may contain, for example, carbon dioxide, water vapor, methane, small amounts of other light hydrocarbons, nitrogen and helium. The gas is treated first in acid gas removal step, 621, and the sweetened gas 622, is sent to dehydration step, 623. Dry, sweet gas stream, 624, is sent on for further processing (not shown) or to the gas pipeline.

Fuel is needed to heat the reboilers used to regenerate the amine scrubbing solution used in step 621. To provide this fuel, a small side stream, 602, is taken from stream 601. This fuel gas stream is passed to filter separator 603, where excess liquids are removed as stream 604. Gas stream, 605, is passed as the feed stream to membrane separation step, 606, which uses membranes, 607, that are selective for helium over methane and nitrogen.

Helium-enriched permeate stream, 609, leaves this step at lower pressure and is passed to another compression step, 610, and cooling step, 611. Recompressed, cooled gas, 612, is passed as feed into second membrane separation stage, 613, containing helium-selective membranes, 614. This stage forms the first step within the second stage. Here the gas is separated into a permeated export helium stream, 616, and second residue stream, 615. The export helium may be sent to another location as crude helium for further processing.

Stream 615, which remains at high pressure, is passed to a second step, 617, of the second stage, again containing helium-selective membranes, 618. This step produces a permeate stream, 620, that is recirculated to the intake of compression step 610, and a residue stream, 619, that is recirculated to the separator at the front of our process. The use of two steps in the second stage enables the stage-cut of step 613 to be held at a low enough value to achieve a relatively high helium concentration in stream 616.

Residue stream 608 from the first membrane stage supplies the helium-depleted fuel gas, which is directed to the combustion fuel intake for the reboiler section of amine scrubbing step, 621.

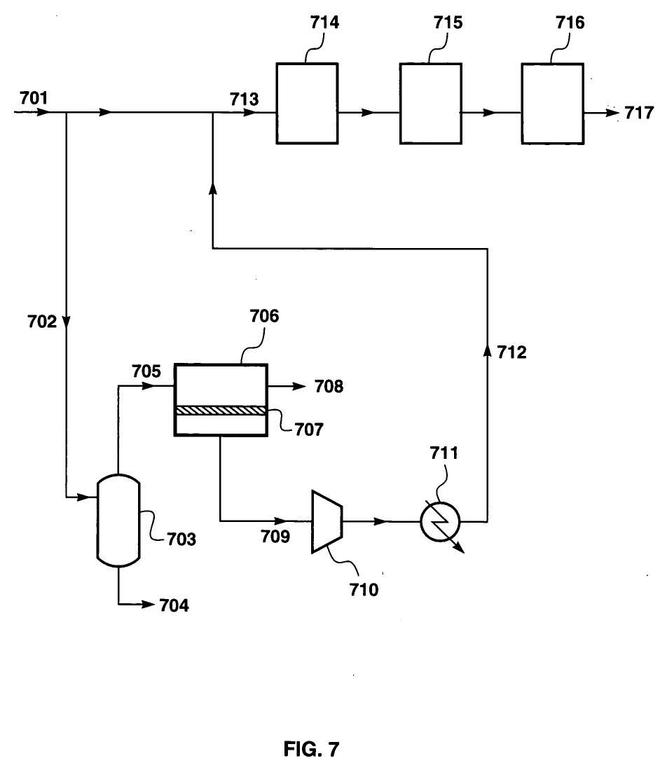

FIG. 7 illustrates a simple alternative to the configuration of FIG. 6 that may optionally be used in a gas plant that has an NRU. Gas stream, 701 is combined with return gas stream 712, discussed below, to form stream 713, which is passed to a train of unit processing steps, 714, 715 and 716 and emerges as product gas 717.

Combustion fuel needed for plant operations is taken as a side stream, 702, from the incoming gas line. The gas is passed first through a phase or filter separator, 703, where liquid stream, 704, is removed. Gas stream, 705, is passed as the feed stream to membrane separation step, 706, which uses membranes, 707, that are selective for helium over methane and nitrogen.

Helium-enriched permeate stream, 709, leaves this step at lower pressure and is passed to recompression step, 710, and cooling step, 711. Recompressed, cooled gas, 712, is returned to the incoming process gas line, thereby recovering at least part of the helium contained in the fuel gas.

Residue stream, 708, supplies the required helium-depleted fuel gas.

The invention is now further described by the following examples, which are intended to be illustrative of the invention, but are not intended to limit the scope or underlying principles in any way.

### EXAMPLES

### Example 1

### Experimental Permeation Data

Composite membranes were prepared using polyetherimide [PEI] support membranes and the following coating materials:
tetrafluoroethylene/2,2,4-trifluoro-5-trifluorometoxy-1,3-dioxole copolymer (Hyflon® AD60), (Solvay Solexis, Thorofare, N.J.)
polyperfluoro(alkenyl vinyl ether) (Cytop(®), (Asahi Glass, Japan)
ethylcellulose [EC].

Composite membranes were prepared using polyvinylidene fluoride [PVDF] support membranes and the following coating materials:
poly(dimethylsiloxane) [PDMS]
poly(1-phenyl1-propyne) [PPP]
poly(3,4,3′,4′-biphenyltetracarboxylic dianhydride-2,4,6-m-phenylenediamine) [BPDA-TMPD]

Samples of each finished composite membrane were cut into 12.6 cm² stamps and tested in a permeation test-cell apparatus with pure gases at 22° C. feed temperature and 65 psia feed pressure. During each test, the feed, permeate, and residue compositions were analyzed by gas chromatography (GC). The gas fluxes of the membranes were measured, and the selectivities were calculated as the ratio of the pure gas fluxes. Table 1 summarizes the fluxes and the calculated selectivities of the composite membranes.

As can be seen, membranes made from any of the materials except silicone rubber would be suitable for use in the invention.

TABLE 1

| | Pure-Gas Pressure- | | | | | |
|---|---|---|---|---|---|---|
| | Normalized | | | Selectivity | | |
| | Flux (GPU) | | | He/ | He/ | |
| Membrane | Helium | Nitrogen | Methane | N₂ | CH₄ | N₂/CH₄ |
| EC | 166 | 36 | 90 | 4.6 | 1.8 | 0.4 |
| PDMS | 280 | 215 | 688 | 1.3 | 0.4 | 0.3 |
| PPP | 375 | 25 | 33 | 15 | 11.4 | 0.8 |
| BPDA-TMPD | 360 | 30 | 34 | 12 | 10.6 | 0.9 |
| Hyflon ® | 500 | 50 | 19 | 10 | 26.3 | 2.6 |
| AD60 | | | | | | |
| Cytop ® | 390 | 14 | 5 | 28 | 78 | 2.8 |

1 GPU = 1 × 10⁻⁶ cm³(STP)/cm² · s · cmHg

### Example 2

### Model of Purge Gas Stream Application

A computer calculation was performed with a modeling program, ChemCad V (ChemStations, Inc., Houston, Tex.), to demonstrate the membrane separation step in the process of the invention according to an embodiment similar to that of FIG. 2. It was assumed that crude helium stream, 213, is compressed and sent for ultimate further processing in a helium purification plant.

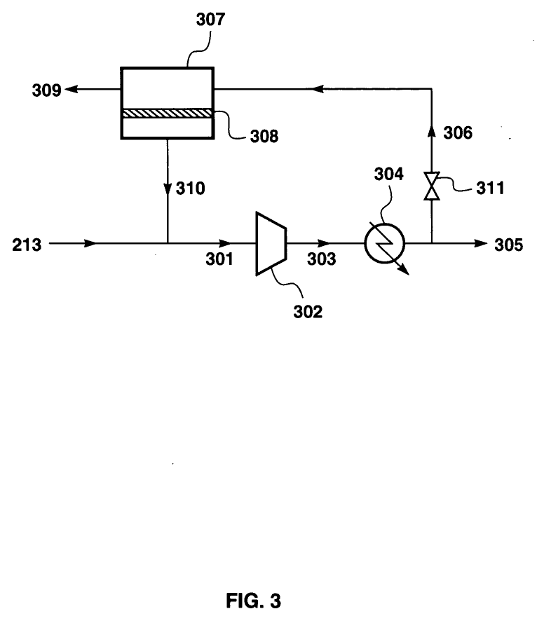

The details of the membrane separation step were assumed to be as shown in FIG. 3. Referring to this figure, crude helium stream 213, was assumed to contain 50 mol % nitrogen and 50 mol % helium. This stream is mixed with membrane permeate stream, 310, and introduced as stream 301 into the suction side of compressor 302, where it is compressed to 1,400 psia. Compressed stream 303 is cooled to 27° C. by heat exchange or otherwise in aftercooler, 304. Cooled crude helium stream 305 passes along the product pipeline.

Side stream, 306, is taken at a reduced pressure of 600 psia from the compressed, cooled pipeline gas through valve, 311 to be used as purge gas in the gas processing plant. Before it is sent to its destination of use, the purge gas is introduced to the feed side of membrane separation unit, 307. The unit contains membranes, 308, that are selective in favor of helium over nitrogen. The permeate side of the membrane is maintained at 60 psia, providing a pressure ratio of 10 across the membrane.

Permeate stream, 310, is returned to the crude helium line upstream of compressor 302.

Residue stream 309 is withdrawn from the feed side of the membrane and provides the required helium-depleted purge gas.

The results of the calculation are shown in Table 2. Stream numbers refer to FIG. 3.

TABLE 2

| | Stream | | | | |
|---|---|---|---|---|---|
| | 213 | 306 | 310 | 309 | 305 |
| Flow (lbmol/h) | 132 | 13 | 11 | 2 | 130 |
| Flow (Mscfd) | 1,200 | 120 | 104 | 16 | 1,184 |
| Pressure (psia) | 55 | 600 | 60 | 595 | 1,415 |
| Temperature (° C.) | 49 | 27 | 21 | 20 | 27 |

Component (mol %):

| | | | | | |
|---|---|---|---|---|---|
| Helium | 50.0 | 50.6 | 58.1 | 1.0 | 50.6 |
| Nitrogen | 50.0 | 49.4 | 41.9 | 99.0 | 49.4 |

As can be seen, the membrane unit recovers essentially all the helium, which is returned to the product pipeline, and produces a nitrogen purge gas stream containing only 1% helium.

### Example 3

### Model of Vent Gas Application

A computer calculation was performed to demonstrate the invention as it applies to treatment of vent gas, according to the embodiment of FIG. 4. The feed was assumed to be nitrogen from the overhead of the cryogenic fractionation column in an NRU. The overhead vent stream, 404, was assumed to be at 25 psia and 38° C., and to be of the following mole percent composition:

| | |
|---|---|
| Helium | 2.7% |
| Nitrogen | 97.3% |

The results of the calculation are shown in Table 3. Stream numbers refer to FIG. 4.

TABLE 3

| | Stream | | | | | | |
|---|---|---|---|---|---|---|---|
| | 404 | 408 | 411 | 412 | 415 | 419 | 418 |
| Flow | 771 | 940 | 715 | 226 | 226 | 56 | 169 |
| (lbmol/h) | | | | | | | |
| Flow | 7.02 | 8.56 | 6.51 | 2:06 | 2.06 | 0.51 | 1.54 |
| (MMscfd) | | | | | | | |
| Pressure | 25 | 257 | 247 | 18 | 267 | 18 | 257 |
| (psia) | | | | | | | |
| Temper- | 38 | 49 | 48 | 48 | 49 | 49 | 48 |
| ature | | | | | | | |
| (° C.) | | | | | | | |

Component (mol %):

| | | | | | | | |
|---|---|---|---|---|---|---|---|
| Helium | 2.7 | 2.7 | 0.7 | 9.0 | 9.0 | 28.0 | 2.7 |
| Nitrogen | 97.3 | 97.3 | 99.3 | 91.1 | 91.1 | 72.0 | 97.3 |

As can be seen, the process produces an enriched helium permeate stream, 419, that contains 28% helium. This stream could be sold as a crude helium product or sent for further processing. After treatment, the nitrogen vent gas stream 411 contains only 0.7% helium. Helium recovery into stream 419 is about 75%.

### Example 4

### Model of Fuel Gas Application

A computer calculation was performed to the invention as it applies to treatment of fuel gas, according to the embodiment of FIG. 5. The fuel gas stream 508 was assumed to be taken off as shown in that figure, to be delivered to membrane step, 509, at 365 psia and 27° C., and to be of the following mole percent composition:

| | |
|---|---|
| Helium | 0.4% |
| Nitrogen | 16.1% |
| Methane | 73.6% |
| Ethane | 6.1% |
| C₃₊ | 3.6% |

The results of the calculation are shown in Table 4. Stream numbers refer to FIG. 5.

TABLE 4

| | Stream | | | | | | |
|---|---|---|---|---|---|---|---|
| | 508 | 508/518 | 511 | 512 | 515 | 519 | 518 |
| Flow | 652 | 721 | 635 | 87 | 87 | 17 | 69 |
| (lbmol/h) | | | | | | | |
| Flow | 5.94 | 6.57 | 5.78 | 0.79 | 0.79 | 0.15 | 0.63 |
| (MMscfd) | | | | | | | |
| Pressure | 365 | 365 | 362 | 18 | 383 | 18 | 365 |
| (psia) | | | | | | | |
| Temper- | 27 | 28 | 27 | 28 | 49 | 48 | 47 |
| ature | | | | | | | |
| (° C.) | | | | | | | |

Component (mol %):

| | | | | | | | |
|---|---|---|---|---|---|---|---|
| Helium | 0.4 | 0.4 | 0.2 | 2.5 | 2.5 | 10.0 | 0.6 |
| Nitrogen | 16.1 | 16.9 | 15.5 | 27.6 | 27.7 | 37.5 | 25.3 |
| Methane | 73.6 | 73.3 | 74.3 | 65.8 | 65.8 | 49.6 | 69.8 |
| Ethane | 6.1 | 5.9 | 6.3 | 2.8 | 2.8 | 1.1 | 3.2 |
| Propane | 3.6 | 3.3 | 0.1 | 0.8 | 0.8 | 0.2 | 1.0 |

As can be seen, the process produces a helium-enriched gas stream 519 containing 10% helium. This stream could be sold as a crude helium product or sent for further processing. After treatment, the fuel gas helium concentration in stream 511 is reduced to half its original value in stream 508. Helium recovery in this case is about 62%.

### Example 5

### Model of Fuel Gas Application

A computer calculation was performed to the invention as it applies to treatment of fuel gas, according to the embodiment of FIG. 6. The fuel gas stream 602 was assumed to be taken off as shown in that figure at the front of the gas processing train and to be of the following mole percent composition:

| | |
|---|---|
| Helium | 0.8% |
| Nitrogen | 1.0% |
| Carbon dioxide | 3.0% |
| Methane | 81.6% |
| Ethane | 7.0% |
| Propane | 4.1% |
| C₄-C₆ | 2.3% |
| Water | 0.2% |
| Hydrogen sulfide | 0.1 ppm. |

The results of the calculation are shown in Table 5. Stream numbers refer to FIG. 6.

TABLE 5

| | Stream | | | | | | |
|---|---|---|---|---|---|---|---|
| | 602 | 605 | 608 | 609 | 612 | 615 | 616 |
| Flow (lbmol/h) | 329 | 360 | 324 | 36.0 | 92.5 | 87.0 | 5.5 |
| Flow (MMscfd) | 3.0 | 3.3 | 2.9 | 0.3 | 0.8 | 0.8 | 0.1 |
| Temp. (° C.) | 27 | 18 | 18 | 18 | 49 | 48 | 48 |
| Pressure (psia) | 365 | 125 | 120 | 20 | 140 | 125 | 50 |

Component (mol %):

| | | | | | | | |
|---|---|---|---|---|---|---|---|
| Helium-4 | 0.8 | 0.8 | 0.5 | 3.0 | 8.4 | 7.8 | 17.8 |
| Nitrogen | 1.0 | 1.1 | 1.0 | 1.8 | 2.3 | 2.3 | 2.4 |
| Carbon Dioxide | 3.0 | 3.1 | 2.5 | 8.5 | 20.1 | 19.3 | 32.7 |
| Methane | 81.6 | 82.3 | 82.3 | 82.9 | 66.3 | 67.7 | 44.6 |
| Ethane | 7.0 | 6.6 | 7.1 | 2.3 | 1.2 | 1.2 | 0.3 |
| Propane | 4.1 | 3.8 | 4.1 | 0.9 | 0.4 | 0.4 | 0.1 |
| C₄-C₆ | 2.3 | 2.1 | 2.3 | 0.04 | 0.02 | 0.02 | — |
| Water | 0.2 | 0.2 | 0.2 | 0.6 | 1.3 | 1.3 | 2.2 |
| Hydrogen | <1 | <1 | <1 | <1 | <1 | <1 | <1 |
| Sulfide (ppm) | | | | | | | |

As can be seen, the process produces a helium-enriched gas stream, 616, containing about 18% helium. This stream could be sold as a crude helium product or sent for further processing. After treatment, the fuel gas helium concentration in stream 608 is reduced to 0.5%. The process provides a helium recovery of about 40%.

### Example 6

### Model of Fuel Gas Application

A computer calculation was performed to demonstrate the invention as it applies to treatment of fuel gas, according to the embodiment of FIG. 7. The fuel gas stream 702 was assumed to be taken off as shown in that figure at the front of the gas processing train and to be of the same mole percent composition as in Example 5, that is:

| | |
|---|---|
| Helium | 0.8% |
| Nitrogen | 1.0% |
| Carbon dioxide | 3.0% |
| Methane | 81.6% |
| Ethane | 7.0% |
| Propane | 4.1% |
| C₄-C₆ | 2.3% |
| Water | 0.2% |
| Hydrogen sulfide | 0.1 ppm. |

The results of the calculation are shown in Table 6. Stream numbers refer to FIG. 7.

TABLE 6

| | Stream | | | | |
|---|---|---|---|---|---|
| | 702 | 705 | 708 | 709 | 712 |
| Flow (lbmol/h) | 416 | 416 | 324 | 92.4 | 92.4 |
| Flow (MMscfd) | 3.8 | 3.8 | 3.0 | 0.8 | 0.8 |
| Temp. (° C.) | 27 | 27 | 24 | 25 | 330 |
| Pressure (psia) | 365 | 365 | 360 | 20 | 375 |

Component (mol %):

| | | | | | |
|---|---|---|---|---|---|
| Helium-4 | 0.8 | 0.8 | 0.1 | 3.3 | 3.3 |
| Nitrogen | 1.0 | 1.0 | 0.8 | 1.7 | 1.7 |
| Carbon Dioxide | 3.0 | 3.0 | 1.4 | 8.7 | 8.7 |
| Methane | 81.6 | 81.6 | 81.4 | 82.3 | 82.3 |
| Ethane | 7.0 | 7.0 | 8.3 | 2.5 | 2.4 |
| Propane | 4.1 | 4.1 | 5.0 | 0.9 | 0.9 |
| C₄-C₆ | 2.3 | 2.3 | 2.9 | 0.05 | 0.05 |
| Water | 0.2 | 0.2 | 0.1 | 0.6 | 0.6 |
| Hydrogen Sulfide (ppm) | <1 | <1 | <1 | <1 | <1 |

As can be seen, the process provides a fuel gas stream 708 that contains only 0.12% helium, compared with 0.82% as it is taken from the main process line. In this case, helium recovery in stream 712 is about 90%. This stream is returned to the process line.

1. A process for capturing helium from a helium-containing reject gas stream at a gas processing plant, comprising the following steps:
(a) providing a membrane unit having a feed side and a permeate side and containing a membrane selective for helium over nitrogen and helium over methane;
(b) passing the reject gas stream as a feed stream across the feed side under conditions in which transmembrane permeation occurs;
(c) withdrawing from the feed side as a residue stream a treated reject gas stream depleted in helium compared with the feed stream;
(d) withdrawing from the permeate side as a permeate stream a gas mixture enriched in helium compared with the feed stream;
(e) disposing of the treated reject gas stream by a method selected from the group consisting of (i) venting, (ii) flaring, (iii) reinjecting, (iv) using as fuel gas and (v) using as purge gas;
(f) disposing of the gas mixture by a method selected from the group consisting of (i) storage, (ii) transport to a helium separation facility, (iii) sale and (iv) return for additional processing within the gas processing plant.

2. The process of claim 1, wherein the reject gas stream comprises helium and nitrogen.

3. The process of claim 1, wherein the reject gas stream comprises helium, nitrogen and methane.

4. The process of claim 1, wherein the reject gas stream comprises helium, methane, carbon dioxide and water vapor.

5. The process of claim 1, wherein the reject gas stream contains less than about 10% helium.

6. The process of claim 1, wherein the reject gas stream is a fuel gas stream.

7. The process of claim 1, wherein the reject gas stream is to be used as a purge gas stream for an operation in the gas processing plant.

8. The process of claim 1, wherein the reject gas stream is a vent gas stream.

9. The process of claim 1, wherein the membrane is operated at a stage-cut of at least about 30%.

10. The process of claim 1, wherein the membrane is operated at a pressure ratio of at least about 10.

11. The process of claim 1, wherein the permeate stream has a helium concentration of at least about 10%.

12. The process of claim 1, wherein at least about 50% of helium contained in the feed stream is captured into the permeate stream.

13. The process of claim 1, wherein the membrane has a selective layer made from a polymer selected from the group consisting of fluorinated dioxoles, fluorinated dioxolanes and fluorinated cyclically polymerizable alkyl ethers.

14. The process of claim 1, wherein the treated reject gas stream is vented.

15. The process of claim 1, wherein the treated reject gas stream is flared.

16. The process of claim 1, wherein the treated reject gas stream is reinjected.

17. The process of claim 1, wherein the treated reject gas stream is used as fuel gas for a piece of equipment selected from the group consisting of engines, turbines, boilers, reboilers and fuel cells.

18. The process of claim 1, wherein the treated reject gas stream is used as purge gas.

19. The process of claim 1, wherein the gas mixture is sold as crude helium.

20. The process of claim 1, wherein the gas mixture is stored.

21. The process of claim 1, wherein the gas mixture is transported to a helium separation facility.

22. The process of claim 1, wherein the gas mixture is returned for additional processing within the gas processing plant.

23. The process of claim 1, further comprising passing the residue stream to a second membrane separation step that produces a second residue stream, so that the second residue stream becomes the treated reject gas stream.

24. The process of claim 1, further comprising passing the permeate stream to a second membrane separation stage that produces a second permeate stream, so that the second permeate stream becomes the gas mixture.

25. A process for capturing helium from a helium-containing vent gas stream at a gas processing plant, comprising the following steps:
(a) providing a membrane unit having a feed side and a permeate side and containing a membrane selective for helium over nitrogen and helium over methane;
(b) passing at least a portion of the vent gas stream as a feed stream across the feed side under conditions in which transmembrane permeation occurs;
(c) withdrawing from the feed side as a residue stream a treated vent gas stream depleted in helium compared with the feed stream;
(d) withdrawing from the permeate side as a permeate stream a gas mixture enriched in helium compared with the feed stream;
(e) venting the residue stream.

26. The process of claim 25, wherein the vent gas stream comprises helium and nitrogen.

27. The process of claim 25, wherein the vent gas stream contains less than about 10% helium.

28. The process of claim 25, wherein the membrane is operated at a stage-cut of at least about 30%.

29. The process of claim 25, wherein the membrane is operated at a pressure ratio of at least about 10.

30. The process of claim 25, wherein the permeate stream has a helium concentration at least about 10%.

31. The process of claim 25, wherein at least about 50% of helium contained in the feed stream is captured into the permeate stream.

32. The process of claim 25, wherein the gas mixture is stored.

33. The process of claim 25, wherein the gas mixture is transported to a helium separation facility.

34. The process of claim 25, wherein the gas mixture is sold as crude helium.

35. The process of claim 25, further comprising passing the permeate stream to a second membrane separation stage that produces a second permeate stream, so that the second permeate stream becomes the gas mixture.

36. A process for capturing helium from a helium-containing fuel gas stream at a gas processing plant, comprising the following steps:
(a) providing a membrane unit having a feed side and a permeate side and containing a membrane selective for helium over methane;
(b) passing at least a portion of the fuel gas stream as a feed stream across the feed side under conditions in which transmembrane permeation occurs;
(c) withdrawing from the feed side as a residue stream a treated fuel gas stream depleted in helium compared with the feed stream;
(d) withdrawing from the permeate side as a permeate stream a gas mixture enriched in helium compared with the feed stream;
(e) burning the residue stream as fuel.

37. The process of claim 36, wherein the fuel gas stream comprises helium and methane.

38. The process of claim 36, wherein the fuel gas stream contains less than about 10% helium.

39. The process of claim 36, wherein the membrane is operated at a stage-cut of at least about 30%.

40. The process of claim 36, wherein the membrane is operated at a pressure ratio of at least about 10.

41. The process of claim 36, wherein at least about 50% of helium contained in the feed stream is captured into the permeate stream.

42. The process of claim 36, further comprising disposing of the gas mixture by a method selected from the group consisting of (i) storage, (ii) transport to a helium separation facility, (iii) sale and (iv) return for processing within the gas processing plant.

43. The process of claim 36, further comprising passing the permeate stream to a second membrane separation stage that produces a second permeate stream, so that the second permeate stream becomes the gas mixture.

44. The process of claim 36, wherein the permeate stream has a helium concentration of at least about 10%.

45. The process of claim 36, wherein the membrane has a selective layer made from a polymer selected from the group consisting of fluorinated dioxoles, fluorinated dioxolanes and fluorinated cyclically polymerizable alkyl ethers.

46. A process for capturing helium from a helium-containing purge gas stream at a gas processing plant, comprising the following steps:
(a) providing a membrane unit having a feed side and a permeate side and containing a membrane selective for helium over nitrogen and helium over methane;
(b) passing at least a portion of the purge gas stream as a feed stream across the feed side under conditions in which transmembrane permeation occurs;
(c) withdrawing from the feed side as a residue stream a treated purge gas stream depleted in helium compared with the feed stream;
(d) withdrawing from the permeate side as a permeate stream a gas mixture enriched in helium compared with the feed stream;
(e) using the treated purge gas stream as a purge stream within the gas processing plant.

47. The process of claim 46, wherein the purge gas stream comprises helium and nitrogen.

48. The process of claim 46, wherein the purge gas stream contains at least about 50% helium.

49. The process of claim 46, wherein the purge gas stream contains less than about 10% helium.

50. The process of claim 46, wherein the membrane is operated at a stage-cut of at least about 30%.

51. The process of claim 46, wherein the membrane is operated at a pressure ratio of at least about 10.

52. The process of claim 46, wherein the permeate stream has a helium concentration of at least about 10%.

53. The process of claim 46, wherein at least about 50% of helium contained in the feed stream is captured into the permeate stream.

54. The process of claim 46, further comprising returning the permeate within the gas processing plant.

55. The process of claim 46, wherein the treated purge stream is used as an insulating gas.

56. The process of claim 46, wherein the treated purge stream is used as a blanketing gas.
